(19) United States
(12) Patent Application Publication
(10) Pub. No.: US 2015/0113874 A1
(43) Pub. Date: Apr. 30, 2015

(54) APPARATUS FOR WATERING PLANTS

(71) Applicant: Kenneth STEMLAND, (US)

(72) Inventor: Kenneth Stemland, Oslo (NO)

(21) Appl. No.: 14/403,520

(22) PCT Filed: May 24, 2013
(86) PCT No.: PCT/NO2013/050094

§ 371 Date: Nov. 24, 2014

(30) Foreign Application Priority Data
May 24, 2012 (NO) 20120616

(51) Int. Cl. A01G 27/00

(52) U.S. Cl. CPC A01G 27/00
USPC 47/79

(57) ABSTRACT

An apparatus to water plants made from a pliable and flexible sheet that, in a storage position, comprises a plane. The apparatus includes an elongated main part with a central, longitudinal axis. The main part includes a first arm that extends along a first edge of the main part on a first side of the longitudinal axis, a second arm that extends along a second edge of the main part on a second side of the longitudinal axis, and a foot that extends along the longitudinal axis between the arms. In an operational state of the apparatus, the edges of the main part are bent up and out from the longitudinal axis and the arms are attached to each other to form a bridge over the main part by a releasable fastener such that the main part forms a trough-shaped bottom along the longitudinal axis.

### CROSS-REFERENCE TO RELATED APPLICATIONS

This application is a 35 U.S.C. §371 national stage application of PCT/NO2013/050094 filed May 24, 2013, entitled “Apparatus for Watering Plants,” which claims priority to Norwegian Application No. NO 20120616 filed May 24, 2012, both of which are incorporated herein by reference in their entirety for all purposes.

### BACKGROUND

This disclosure concerns an apparatus for watering plants. The apparatus can be used as rain collector and/or during manual watering.

The Earth's population increases, and a substantial part of the population growth comes in countries with little rainfall and where the population is relatively poor. Environmental changes with higher temperatures make the water shortage worse. In order to grow food for an increasing number of people, there is thus a need for simple and inexpensive means to utilize the water in the best possible manner. More particularly, there is a need for a collector that alleviates the access to water from rain and dew to a cost that enables a large portion of the world's population to use the technique. In dry parts of the globe, the collector's ability to catch dew and lead the water to containers also be very important. A rain collector can also provide shadow from the sun and protect against sand and wind.

Rain collectors with a surface collecting rain and/or dew, and a guide to be inserted into the earth to lead water to the soil are known. These also provide shadow and protection.

Such known rain collectors are often made from metal or rigid plastic. This gives them a rigid shape that causes a number of problems. A first problem is that known rain collectors occupy much space during storage and transport. A second problem is that they cannot be bent or adjusted between the plants, and thus may harm the plant. Neither can the face collecting rain be disposed approximately vertical. A steeper angle of the condensation face causes vapour condensing on the face easily flow away, which is an advantage when the collector operates as a dew collector. When the angle between the condensation face is less, e.g. 30°-45°, the dew collecting is less efficient.

The fixed angle between the guide and the collecting face, in addition to the weight of the rain collector, means that such rain collectors are difficult to insert in a light container, for example a bottle, and lead dew into the bottle without causing the bottle to tip over. If the bottle is stabilized, dew may be guided from the upper side of the bottle, while dew collected on the underside will hit the bottleneck and flow down on the outer face of the bottle and be lost. Thus, such rain collectors will merely collect dew from half of its surface area.

For known rain collectors of metal, e.g. from aluminum or an aluminum alloy, the manufacture of the rain collector is energy consuming and not very environment friendly. For example, electrolysis of aluminum a very energy consuming process that is not environment friendly and increases the price of the finished product due to the energy cost for production. In addition, a sharp metal can harm the roots and root development of certain plant species. Besides, metal, e.g. Al, are very good heat conductors, and thus conduct heat efficiently into the soil. This increases evaporation from the soil, decreasing the effect of the supplied liquid.

Known collectors of rain and dew adapted for use in flower pots, balcony trays etc., are prone to many of these problems. In such applications the problems are enhanced because flower pots and other vessels contain relatively small volumes that dry out more easily than a larger volume in which heat from the sun can be distributed without increasing the temperature to the same extent as in a small vessel.

An objective of the present disclosure is to provide an improved apparatus for watering plants that is inexpensive to manufacture, simple in use and that solves at least one of the problems above.

### SUMMARY

This is achieved according to the present disclosure by an apparatus according to claim 1, more particularly by an apparatus for watering plants made from a pliable, flexible sheet, that in a storage position comprises a plane, distinguished in that an elongated main part with a central, longitudinal axis, wherein a first arm extends along a first edge on a first side of the longitudinal axis, a second arm extends along a second edge on a second side of the longitudinal axis and a foot extends along the longitudinal axis between the arms; wherein the apparatus has an operational state wherein the edges of the main part are bent up and out from the longitudinal axis and the arms are attached to each other in a bridge over the main part by releasable fastening means such that the main part forms a trough-shaped bottom along the longitudinal axis.

In another aspect, the disclosure regards a method for manufacturing such an apparatus from a thin sheet.

Storage and transport are simplified in that the apparatus permits storage and transport as a stack of thin sheets. The collector can have a foot to be inserted into the soil by a plant and a tongue leading water to the soil near the root of the plant. The collector is preferably made from a recyclable plastic such as polypropylene (PP) or polyethylene (PE) that limits heat transport from the main part to the soil around the plant.

Other features and embodiments appear from the dependent claims.

### BRIEF DESCRIPTION OF THE DRAWINGS

The invention will be described in the following by means of exemplary embodiments and with reference to the accompanying drawings, in which:

FIG. 1 is a top view of a collector cut out from a thin sheet;

FIG. 2 is a top view of the collector on FIG. 1 wherein the arms are attached to each other;

FIG. 3 is a side elevational view of the collector on FIG. 1;

FIG. 4 shows the collector on FIG. 1 in use at a plant;

FIG. 5 is a top view of an alternative embodiment;

FIG. 6 shows the embodiment from FIG. 5 in perspective; and

FIG. 7 shows the collector on FIG. 5 in use.

### DETAILED DESCRIPTION

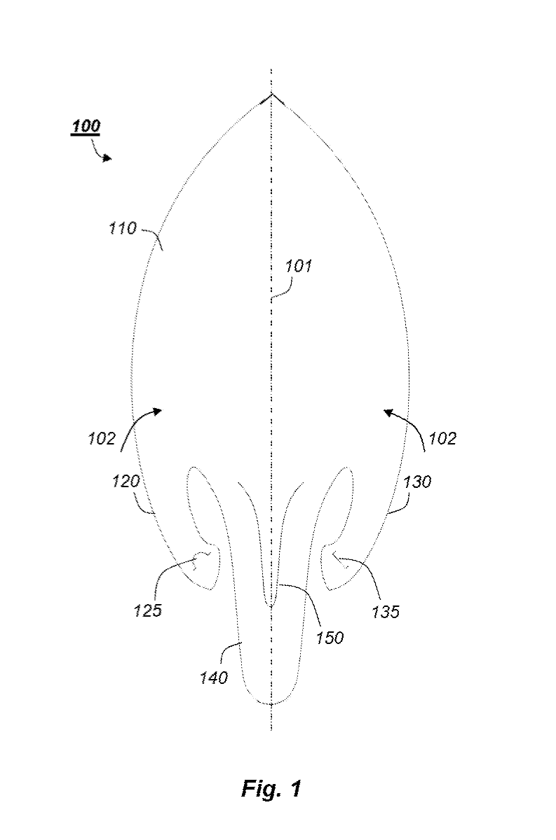

FIG. 1 illustrates a preferred embodiment of a collector 100 viewed from above, and is shown in the drawing in a storage position wherein the upper face of the sheet forms a plane. The collector 100 can be cut out of a thin sheet, e.g. by punching, cutting by wire or saw or in another known manner. Alternatively, the shape on FIG. 1 can be cast using a suitable technique.

The longitudinal axis 101 is an imaginary axis shown to facilitate the description. There is no presumption that the collector is mirrored about the shown longitudinal axis. The collector 100 has a main part 110 with two arms 120 and 130, which in this embodiment in operation are bent up from the sheet, i.e. out from the paper plane in FIG. 1. In operation, the edges are thereby the edges bent upward as indicated with the arrows 102, and the arms are attached to each other in a bridge over the main part 110 by a hook 125 on the first arm 125 is inserted in a notch 135 on the other arm 130. Alternative embodiments wherein the arms are separated, that is wherein the edge, contour or edge line of the main part extend into the main part 110 on either side of the longitudinal axis 110 from the lower part upwards, are within the scope of the present disclosure. For example, the first arm can be inserted in a holder on the other end in a solution wherein the tension in the bridge can be adjusted. The collector 100 further comprises a foot 140 extending in the extension of the main part 110 along the axis 101 and between the arms 120 and 130, In operation, the foot 140 is inserted in the soil at a plant, and a tongue 150 leads water from the main part 110 to an area at the root of the plant as shown on FIG. 4.

As mentioned, preferably materials with a low thermal conductivity are used, thus conducting a low amount of heat into the soil with subsequent liquid loss at the plant. Low thermal conductivity also enables the apparatus to cool down rapidly by the ambient air temperature in the evening and at night, while the soil will still be warm after high temperatures during the day. This improves the formation of dew and the collecting abilities of the apparatus. A suitable material is thin sheets of polypropylene (PP). Sheets of PP, possibly in combination of polyethylene (PE) can be provided with desired rigidity and flexibility for example by adjusting the thickness of the sheet or by additives. PP can also be stabilized in order to withstand sunshine, is relatively environmentally friendly to produce and emits few or none hazardous substances during combustion or recycling. A preferred material is recyclable plastic, but other materials with sufficient flexibility, elasticity and rigidity can be utilized in the present disclosure.

The apparatus is an aid primarily for collecting and supplying water from a rainfall or dew. The collected liquid can be led directly in toward plants in a field, in a flower bed, to potted plants or flower trays, or to collecting units such as bottles, pots, cans, buckets etc.

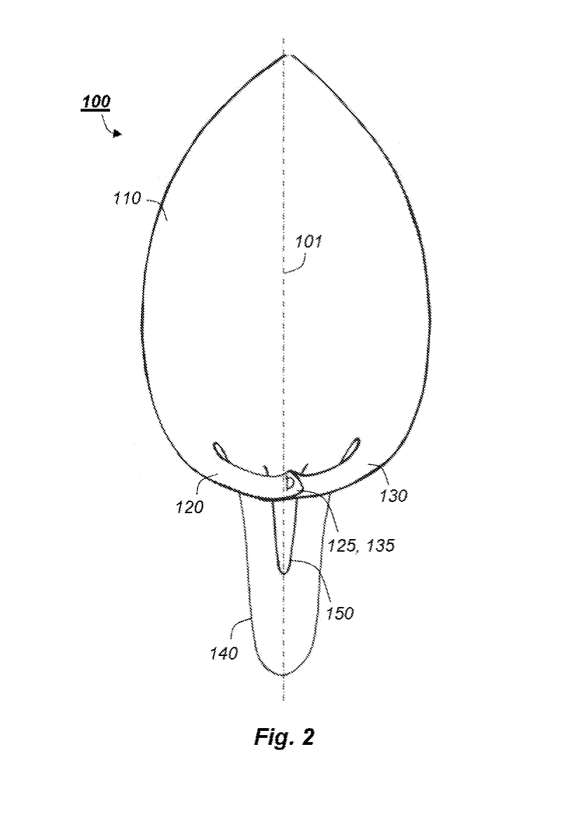

FIG. 2 shows the embodiment on FIG. 1 in an operational state, wherein the arms 120 and 130 are bent up and attached to each other. Thereby, the arms 120 and 130 form a bridge over a trough-shaped bottom formed by the main part 110. Several apparatus in this state can be inserted into each other by pushing the foot 140 on an upper apparatus 100 under the bridge on a corresponding apparatus below.

In order to achieve what is described this far, it suffices that the apparatus is made of a pliable material. However, the material should preferably also be flexible, such that the attachment between the arms can be released and the apparatus can be bent back to its original shape and be stored or transported in a stack, for example between growing seasons, when the apparatus 100 is not in use.

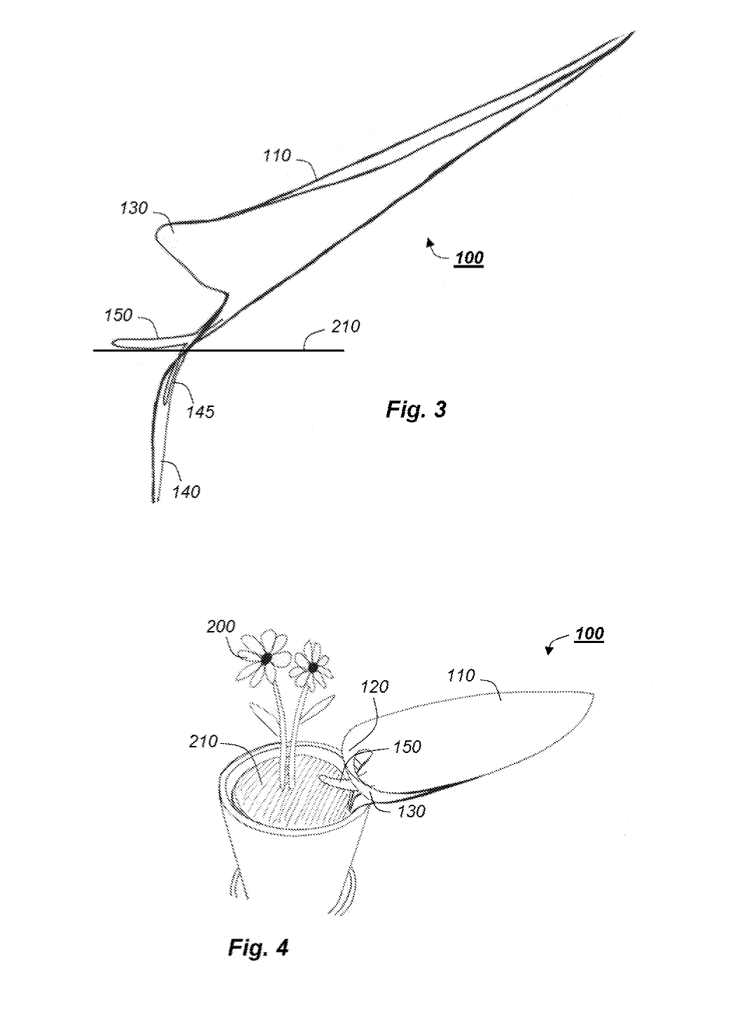

FIG. 3 shows the apparatus viewed from a side. The reference numerals are as above, with an added surface 210, which illustrated that the foot 140 is inserted into the soil, and an opening 145 in the foot 140. The opening 145 appears when the tongue 150 is bent out of the plane from which it is cut. In FIG. 3 it appears that the lower edge of the tongue 150 also functions as a support against the surface 210. The tongue can, if desired, engage a plant. In operation, the tongue 150 rests against the soil surface 210 or the plant, such that it helps angling the blade or main part 110 away from the plant and outside of the edge of the pot. The angle between the main part 110 and the surface 210 is, in this case, also of the edge of the pot. By displacing the foot 140 up or down with respect to the surface 210, and if desired add soil under the end of tongue 150, the angle between the trough-shaped main part 110 and the surface 210 be adjusted.

Alternatively, the main part 110 can be made of material so thin that it is bent backward by its own weight. The tongue 150 leads liquid, in particular rain water and/or condensed dew, closer to a plant, or toward the centre of the pot (FIG. 4), which increases the water supply to the plant. Finally, the soil may be packed lightly around the foot 140 to attain a better grip for the apparatus, e.g. such that is does not blow away in strong wind.

FIG. 4 shows the apparatus 100 disposed in a flower pot. The open foot 140 is inserted in the pot in the area between the soil and the inner side of the pot. In this area, the resistance from the soil will be at a minimum for the pliable material, and the edge and pressure of the soil will help to maintain the pliable material plane whilst it is inserted in the pot and avoid bending of the material.

The location at the edge of the pot causes the product's collection area to extend beyond the collection area of the pot, and thus the plant is supplied with as much water as possible with a least possible overlap of the collection areas of the pot and the product.

The apparatus can be moved to some extent when mounted, and it can therefore be inserted in openings in a fence or similar if it is desired that the plant should be placed in shadow, under a roof or protected from wind, while the apparatus can collect rain, dew or dripping water from roofing and dripping edges.

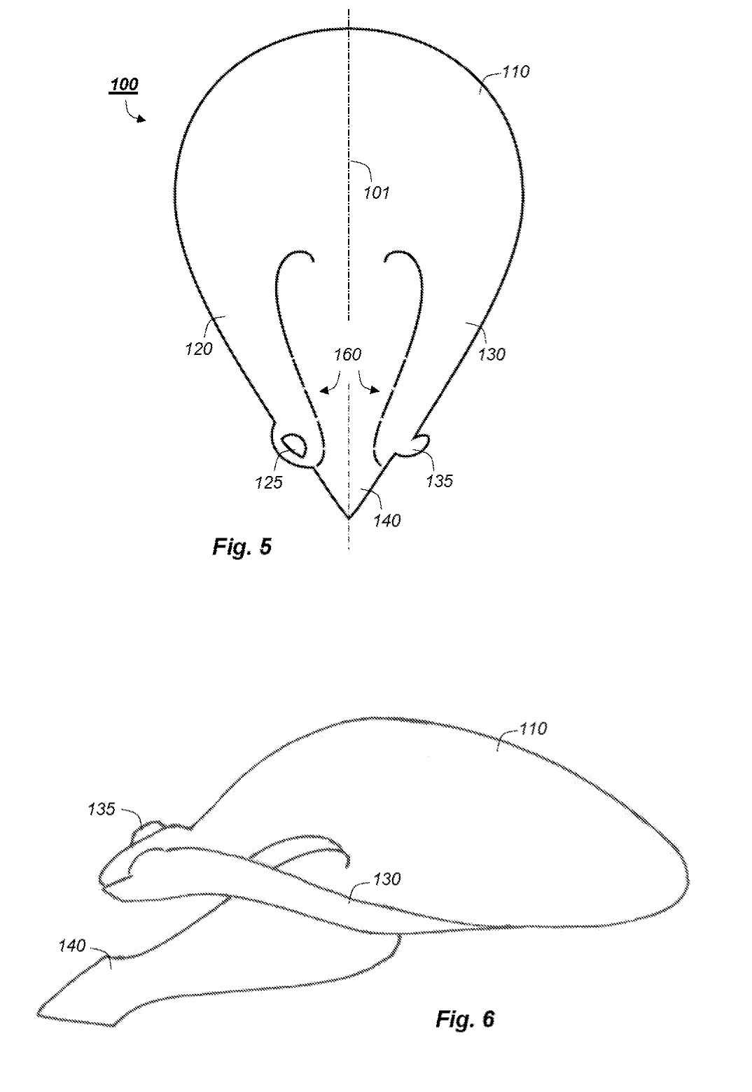

FIG. 5 shows an alternative embodiment without the tongue 150, wherein the angle between the main part 110 and the ground can be adjusted by means of the arms 120 and 130. This makes it possible to provide a smaller foot without diminishing its strength, and thereby achieve a smaller and less expensive product. The apparatus 100 on FIG. 5 has a main part 110, and is shown in a storage state wherein it can be manufactured, stored and stacked as the embodiment in FIG. 1.

The releasable attachment means 125, 135 are disposed on the outer sides, i.e. on the sides of the respective arms 120, 130 that face away from the longitudinal axis 101 when the apparatus is in its storage state as shown on FIG. 5.

In FIG. 5, the arms 120 and 130 are coupled to the foot 140 with a partly broken-through line 160. The partly broken-through lines 160 attach the arms 129 and 130 to the foot 140 in the storage state, but are easily broken in order to release the arms from the foot 140 once the apparatus is to be used to guide water. The attachment means 125 and 135 correspond to the attachment means 125 and 135 on FIG. 1. It is irrelevant for the operation which arm 120 or 130 is provided with a hook and which is provided with a complementary notch.

FIG. 6 shows the embodiment from FIG. 5 in the operational state. The arms 120 and 130 are attached to each other in a bridge over the main part 110 and the foot 140. FIG. 6 illustrates the effect of the attachment means being disposed on the outer sides. This location causes the arms to twist about their respective longitudinal axes when the attachment means are connected to a bridge. This improves the strength in the depth-direction, i.e. in a plane perpendicular to the main part through the longitudinal axis 101, such that the tension provided by the connection increases. On FIG. 6, it is clearly seen that when the foot 140 is inserted into the soil, the bridge rests on the surface. Thus, the angle between the main part 110 and the ground can be adjusted by controlling how deeply the foot 140 is inserted in the ground. The foot 140 further comprises a one-way hook that makes it a little harder to pull the foot out from the soil. Thus, the angle between the main part 110 and the horizontal plane can be adjusted without the tension in the sheet pulling the foot 140 out of the soil.

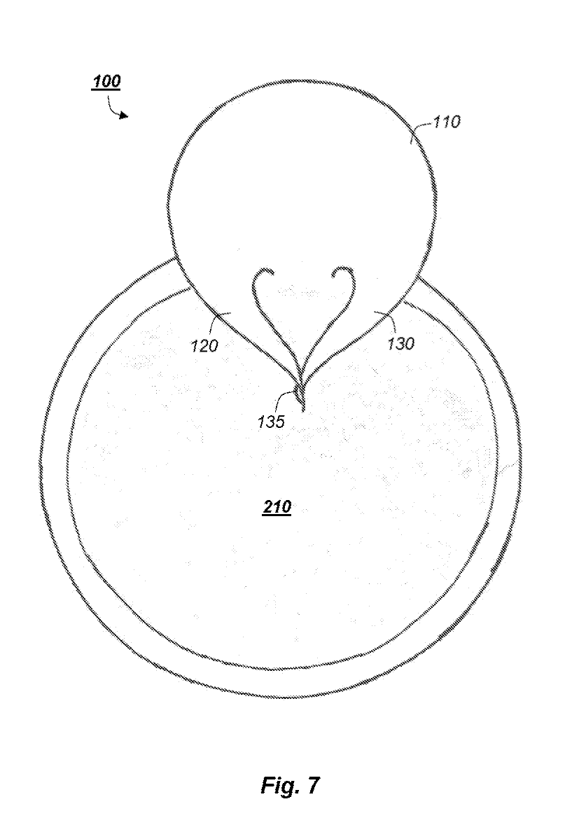

FIG. 7 shows a flower pot with the apparatus 100 in the operational state. The foot is inserted into the soil, and the distal ends of the arms 120 and 130 rest on the surface 210 such that the main part 110 extends beyond the edge of the pot and outside the foliage (not shown) of a plant in the pot. Water applied to the main part 110 is led toward the centre of the pot below the foliage of the plant.

Both embodiments discussed above can be combined with other functions. For example, the main part 110 also be used to reflect light toward the plant.. By selecting a suitable colour or use a material that changes colour under different lighting conditions, the apparatus can in some instances increase the growth of the plants.

If desired, the apparatus can be made such that the main part 110 or other parts of the apparatus changes curvature depending in the intensity of the sunlight. For example, a horizontal face as large as possible might be advantageous during a rainfall. Another example is that a condensation surface arranged approximately at a 90° angle to the ground causes a faster liquid flow when the apparatus is operated as a dew collector at night as discussed in the introduction. The curvature of one part, i.e. the shape of the apparatus, can be changed depending on temperature and/or the intensity of the sunlight in a practical manner by providing the collector with two or more layer and/or regions with different thermal expansion coefficients. Then, the layers and/or regions will expand differently according to the temperature and change the shape of the apparatus. If the apparatus has a colour that absorbs much of the energy in the sunlight, i.e. a relatively dark colour, then the temperature in the apparatus depend on the intensity of the sunlight, and the different layers and/or regions will expand or retract differently such that the curvature of the main part 110 changes in the desired manner. All such variations are within the scope of the present disclosure.

A third possibility is to coverall or parts of the apparatus with a foil, e.g. a foil with solar cell technology for collecting solar energy for various purposes. This solution can also be provided under the blade if the blade is lifted in intense sunlight (see above), and thereby attain a correct angle toward the sun, while the plant simultaneously is protected from evaporation. The energy can be stored in batteries and/or to heat control where a heating element is provided in the ground or is attached to the plant and is activated when the temperature approaches the freezing point, and thus rescue the plant through the night. Night frosts occur in tropical regions, which also contributes to the large formation of condense seen in tropical regions. Alternatively, the main part 110 can be made of an energy absorbing material such as for example a pliable solar cell panel. Both colour and solar cell foil absorb parts of the impinging light spectrum and reflect other parts of the spectrum. Both improve the growth conditions for the plants.

The apparatus 100 can be made in a simple manner by punching out a desired shape, for example as shown in FIGS. 1 and 5, of a plane sheet. Alternatively, the desired shape can be cut out of sheet by a suitable tool, e.g. a saw, a water jet with abrasives, a laser beam or by another known method for cutting sheets. When the apparatus is manufactured from a thin, plane sheet, it is also convenient to tint the sheet and, if desired, print text and/or images on its surface. Punching, tinting and printing can in many instances be combined into one process in one machine. This may reduce the cost of manufacture.

The desired shape can also be cast, e.g. by injection casting, film casting or another known technique. This ensures little excess material, and one can provide non-uniform thickness on the main part 110, and thus optimize the function, for example, regarding the ability of the tongue 150 (FIG. 1) or the arms 120, 130 (FIG. 5) to angle the main part correctly, and to provide hooks/retainers (not shown) retaining the main part 110 in the soil in wind, and that retain both in the side- and depth directions. One might injection cast flat varieties with removable bridge as well as varieties with a permanent bridge. The permanent bridge can then be relatively thin, and contribute further to a low material consumption. The material and function of the product would otherwise be equal, i.e. for example pliable PP or PE etc. A possible drawback of casting compared to punching is longer manufacture time per unit.

Of course, the choice of material and manufacturing method may be adapted to the application at hand, and it is possible to produce large quantities of the apparatus to a relatively low price per unit with simple and easily available technology. This makes the apparatus attractive in poor parts of the world as well as extra equipment to pots and trays in other parts of the world.

The design and size of the apparatus also make it suitable for use as an information label for plants, wherein e.g. information about the plant and its care can be printed on one or both sides. In a shop, an approximately vertical orientation for the best possible exposure of images and text facing potential customers when the plant is exhibited on a table or a shelf. However, in a home the vertical position might be less desirous as the label would be disturbingly visible at a distance, and close to invisible when viewed from above during tending or watering. By using labels that can be angled and assume a funneling function, one achieves that the label are less visible or disturbing from a distance, that it provides a large area for watering with reduced risk for spilling and as collector of rain and dew outside the home. The label thus becomes more visible in situations where the plant is tended such that the advice and tips printed on the label become easy to read when needed.

Such a function also makes the label to a more effective tool for conveying information and messages printed on the sheet, including marketing. One example is to utilize QR-codes scannable by mobile data- and mobile units, and which automatically connects the customer to a specific web page or to an application that can be downloaded to the unit. The fact that a label satisfying an enhanced practical function will be kept by the customer over time rather than being thrown away makes the label further effective as an information carrier.

In order to achieve an improved label function, the arms 120 and 130 are preferably partly attached to the foot 140 with a partial break-through line 160 as illustrated on FIG. 5. Such an attachment enables the arms 120 and 130 aids in supporting the label as it is inserted in the soil or in fastening mechanisms in the flower pot. When the owner of the flower so desires, the label can be retrieved from the pot, the arms released from the foot by pulling in them such that the break-through line rips open, the arms attached to each other with the fastening means 125 and 135, and the label reinserted in the soil such that the desired angled orientation of the label is achieved.

While the apparatus is described above by means of specific embodiments, the scope of the present disclosure is defined by the attached claims.

What is claimed is:

1. An apparatus to water plants made from a pliable and flexible sheet that, in a storage position, comprises a plane, the apparatus comprising;
an elongated main part with a central, longitudinal axis, the main part comprising:
a first arm that extends along a first edge of the main part on a first side of the longitudinal axis
a second arm that extends along a second edge of the main part on a second side of the longitudinal axis; and
a foot that extends along the longitudinal axis between the arms;
wherein in an operational state of the apparatus, the edges of the main part are bent up and out from the longitudinal axis and the arms are attached to each other form a bridge over the main part by a releasable fastener such that the main part forms a trough-shaped bottom along the longitudinal axis

2. The apparatus according to claim 1, further comprising a tongue attached to the main part at a proximal end that extends parallel to the longitudinal axis and that has a distal end configured to be swung out of the plane.

3. The apparatus according to claim 1, wherein the apparatus is configured to be inserted into other apparatuses when in its operational state.

4. The apparatus according to claim 1, further comprising two or more layers or regions with different thermal expansion coefficients.

5. The apparatus according to claim 1, wherein the main part comprises a pliable solar cell panel.

6. The apparatus according to claim 1, wherein the releasable fasteners are disposed on the sides of the respective arms facing away from the longitudinal axis when the apparatus is in its storage state.

7. A method for manufacture of an apparatus according to claim 1, comprising producing cuts in the pliable, flexible sheet, wherein the cuts defining the parts of the apparatus.

8. The method according to claim 7, wherein producing cuts comprises punching out one continuous part from the sheet.

9. The method according to claim 7, wherein producing cuts comprises casting the sheet.

10. The method according to claim 7, further comprising printing information on the sheet.
